(19) United States
(12) Patent Application Publication
(10) Pub. No.: US 2024/0035285 A1
(43) Pub. Date: Feb. 1, 2024

(54) BUILDING COMPONENTS, STRUCTURES FORMED THEREFROM AND RELATED METHODS

(71) Applicants: Casey S. Keller, Bountiful, UT (US); Tyler Whitehead, Woods Cross, UT (US)

(72) Inventors: Casey S. Keller, Bountiful, UT (US); Tyler Whitehead, Woods Cross, UT (US)

(21) Appl. No.: 18/354,911

(22) Filed: Jul. 19, 2023

Related U.S. Application Data
(60) Provisional application No. 63/392,865, filed on Jul. 28, 2022.

(51) Int. Cl. E04F 11/104; B32B 25/14; B32B 21/04; B32B 3/04; B32B 3/30; B32B 7/08; E04F 11/108; E04F 11/17

(52) U.S. Cl. CPC E04F 11/1043; B32B 25/14; B32B 21/045; B32B 3/04; B32B 3/30; B32B 7/08; E04F 11/108; E04F 11/17; B32B 2419/00; B32B 2270/00; B32B 2307/4026; B32B 2272/00; B32B 2307/7376; E04F 11/025

(57) ABSTRACT

Building materials described herein include a structure having a substrate and a coating formed on the substrate. In one embodiment, the coating may include a mixture or rubber in urethane. For example, in one embodiment, mixture may include approximately 8% to approximately 12% by weight of urethane, approximately 2% to approximately 5% by weight of water, and approximately 81% to approximately 90% by weight of rubber. In some embodiments, the mixture may include a colorant, a fire retardant, and/or an ultraviolet (UV) inhibitor.

### CROSS-REFERENCE TO RELATED APPLICATIONS

This application claims the benefit of U.S. Provisional Patent Application No. 63/392,865 entitled BUILDING COMPONENTS, STRUCTURES FORMED THEREFROM AND RELATED METHODS, filed on Jul. 28, 2022, the disclosure of which is incorporated by reference herein in its entirety.

### BACKGROUND

Many residential and commercial facilities include staircases that utilize pre-formed or prefabricated stair treads. For example, precast concrete stair treads are a popular choice for use in building staircases. However, precast concrete stair treads can require significant maintenance in order to provide longevity and durability. Often, such treads need frequent replacement because of deterioration and can become hazardous to those using the stairs. In one example, exterior installation can result in the treads being subjected to extreme temperatures, snow, ice, salt, and other environmental conditions that cause corrosion, cracking, and other deleterious effects. Such treads may need to be replaced within a matter of a few years or risk being a hazard to the users. Additionally, stair treads formed of conventional materials (e.g., precast concrete or metal) can provide some undesirable ergonomic qualities

There is an ongoing need for improved building materials, methods of making such materials, and structures formed using these building materials and methods. Such building materials may provide improved durability and/or improved ergonomic characteristics, such as, for example, reduced noise, increased grip, a softer feel, or some combination thereof.

### SUMMARY OF THE DISCLOSURE

The present disclosure provides various embodiments associated with building materials that may be used, for example, in residential and/or commercial settings. The present disclosure additionally provides for methods of forming such materials, methods of using such materials, and resulting structures.

In accordance with one embodiment, a stair tread is provided which comprises a substrate and a coating over at least a portion of the substrate, the coating comprising rubber and urethane.

In one embodiment, the substrate comprises a length of dimensional lumber.

In one embodiment, the coating further comprises water and a colorant

In one embodiment, the rubber comprises recycled rubber.

In one embodiment, the coating exhibits a thickness of approximately 0.375 inch.

In one embodiment, the coating entirely envelopes the substrate.

In one embodiment, a pattern of raised features is molded into a surface of the coating.

In accordance with another embodiment of the present disclosure, a staircase comprises at least one stringer, at least one stair tread coupled with the at least one stringer, wherein the at least one stair tread comprises a substrate and a coating over at least a portion of the substrate, the coating comprising rubber and urethane.

In one embodiment, the at least one stair tread is coupled directly to the at least one stringer by way of a wood screw.

In one embodiment, the substrate comprises a length of dimensional lumber.

In one embodiment, the coating further comprises water and a colorant, and wherein the rubber comprises recycled rubber.

In one embodiment, the coating exhibits a thickness of approximately 0.375 inch.

In one embodiment, the coating entirely envelopes the substrate.

In one embodiment, a pattern of raised features is molded into a surface of the coating.

In one embodiment, the at least one stair tread is attached to the at least one stringer by way of a bracket.

In one embodiment, the at least one stringer includes a plurality of stringers and wherein the at least one stair tread includes a plurality of stair treads.

In accordance with another embodiment of the present disclosure, a method of forming a building component is provided. The method comprises providing a mixture of rubber and urethane, placing a substrate in a mold, surrounding the substrate with the mixture, and bonding the mixture to the substrate.

In one embodiment, the method further comprises forming the mixture with approximately 8% to approximately 12% by weight of urethane, approximately 2% to approximately 5% by weight of water, and approximately 81% to approximately 90% by weight of rubber.

In one embodiment, the method further comprises forming the mixture with at least one of a colorant, a fire retardant, and a UV inhibitor.

In one embodiment, forming the mixture includes providing rubber at a size of approximately 20 mesh.

In one embodiment, bonding the mixture to the substrate includes subjecting the substrate and the mixture to a temperature of between approximately 100° C. and approximately 130° C. and to a pressure of between approximately 80 bar and approximately 110 bar for a time of approximately 12 minutes.

In one embodiment, the method further comprises molding a pattern of raised elements into a surface of the mixture.

In one embodiment, the method further comprises providing the substrate as a length of dimensional lumber.

In one embodiment, bonding the mixture to the substrate results in a coating of approximately 0.375 inch of the mixture on the substrate.

It is noted that features, aspects, elements or components of one described embodiment may be incorporated with features, aspects, elements or components or other described embodiments without limitation.

### BRIEF DESCRIPTION OF THE DRAWINGS

The foregoing and other advantages of the invention will become apparent upon reading the following detailed description and upon reference to the drawings in which:

FIG. 1 is a flow diagram illustrating a method of forming building materials according to an embodiment of the present disclosure;

FIGS. 2A-2C show a top view, a front view, and a side view, respectively, of a stair tread in accordance with an embodiment of the present disclosure;

FIG. 3 is an enlarged cross-sectional view as taken along the lines 3-3 in FIG. 2B;

FIG. 4 is a perspective view of a staircase in accordance with an embodiment of the present disclosure; and

FIGS. 5A and 5B illustrate potential mounting methods of a stair tread in accordance with embodiments of the present disclosure.

### DETAILED DESCRIPTION

Various embodiments described herein are directed toward building components, structures formed using such components, and methods of making and using such components.

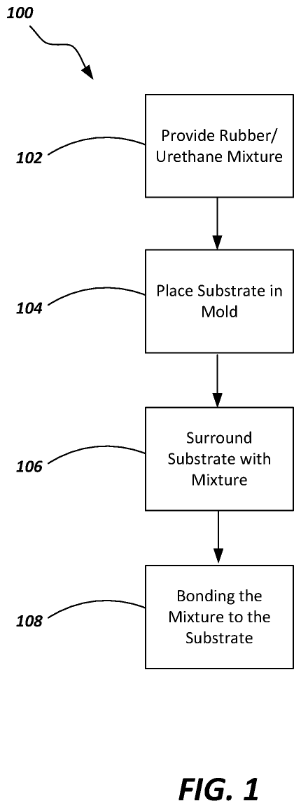

Referring to FIG. 1, a method 100 of forming a building component according to an embodiment of the present disclosure is illustrated. The method 100 includes providing a mixture of rubber and urethane as indicated at 102. In one example, the mixture may be formed by mixing urethane, water, and rubber together. In some embodiments, colorant may also be included in the mixture. In one particular example, the mixture may comprise approximately 8% to approximately 12% of urethane by weight, approximately 2% to approximately 5% of water by weight, up to approximately 2% of colorant by weight, and approximately 81% to approximately 90% rubber by weight. In one example, the rubber may be provided in a shred size of approximately 20 mesh. In another embodiment, the rubber may be provided in a shed size of between approximately 15 mesh and approximately 25 mesh. In one embodiment, the rubber may be recycled rubber.

In some embodiments, other constituents may be added to the mixture. For example, fire retardant chemicals or materials may be included in the mixture. In another example, a UV (ultraviolet) inhibitor may be added to the mixture in order to prevent breakdown of the resulting coating formed by the mixture when used in an external environment.

In one particular embodiment, the act 102 of forming the mixture may include adding the desired amount of rubber into a mixer, adding the desired amount of urethane to the mixer, adding a desired amount (if any) of colorant to the mixer, and then mixing these components for approximately 4 minutes. Following the mixing, the desired amount of water is added to the mixer and the water and previously added components are mixed for approximately 1 minute.

The method 100 further includes placing a substrate in a mold as indicated at 104. In one example, the substrate may include a wooden member such as a “2×12” (a common designation in the United Stated for a piece of wood that is nominally 2 inches thick, 12 inches wide, and any specified length) or some other length of dimensional lumber (e.g., 2×4, 2×6, 2×8, 2×10).

As indicated at 106, the method 100 includes surrounding the substrate material with the mixture. In one embodiment, a portion of the mixture may be placed in a mold prior to placing the substrate in the mold (e.g., to provide coating along a bottom surface of the substrate material from the mixture), and additional mixture material may then be placed around the remaining portions of the substrate. In some embodiments, the mixture may be heated to a desired temperature prior to placing in in the mold. In some embodiments, the mold or other tooling may be heated prior to introducing the mixture.

As indicated at 108, the method 100 also includes bonding the mixture to the substrate. In one embodiment, the act of bonding may include closing the mold and applying heat and pressure to substrate and mixture at an elevated pressure and temperature. For example, the mold may be baked at a temperature of between approximately 100° C. and approximately 130° C. at a pressure of between approximately 80 bar and approximately 110 bar for a time of approximately 12 minutes. The method 100 provides a building component having rubber bonded to the substrate with the rubber exhibiting a desired thickness on all surfaces of the substrate material. It has been determined that the inclusion of urethane in the mixture enhances the bonding of the mixture to the substrate when using wood or similar type materials as the substrate. Following the bonding of the rubber to the substrate, the resulting structure may be removed for use as a building component, such as in the examples described below.

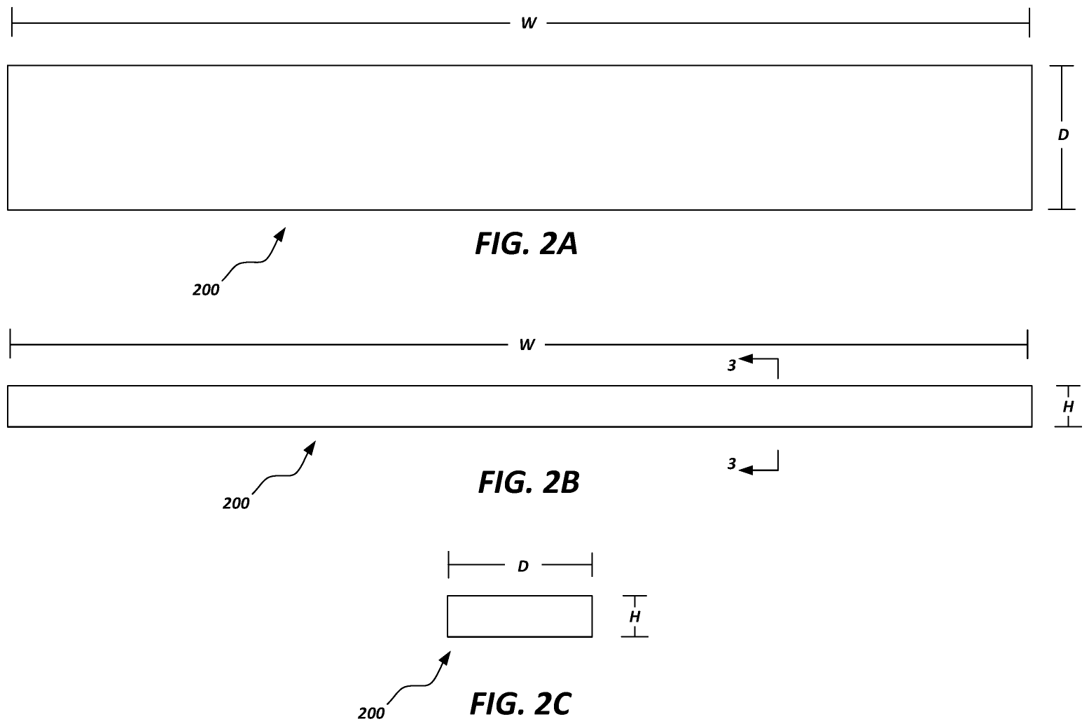

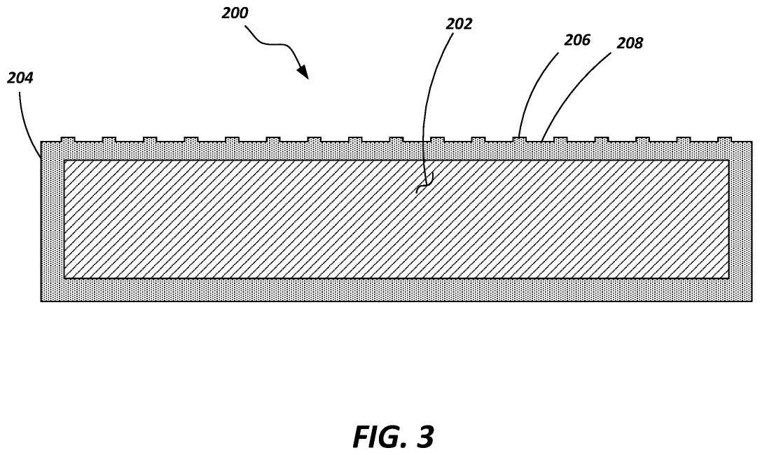

Referring to FIGS. 2A-2C, a stair tread 200 formed in accordance with the above-described method is illustrated. The stair tread 200 exhibits an overall width W, an overall depth D, and an overall height H. In one embodiment, the width W may be approximately 44 inches, the depth D may be approximately 12 inches, and the height H may be approximately 2.25 inches. As shown in FIG. 3 (which depicts a cross-sectional view of the stair tread 200 taken along lines 3-3 in FIG. 2B), the stair tread 200 includes a substrate 202 surrounded by a coating 204 formed from a rubber/urethane mixture. Using the example noted above with respect to various dimensions, the corresponding width of the associated substrate 202 may be approximately 43.25 inches, the corresponding depth of the substrate 202 may be approximately 11.25 inches, and the corresponding height of the substrate 202 may be approximately 1.5 inches, making the thickness of the coating approximately 0.375 inch on each side of the substrate 202.

In other embodiments, the overall dimensions of the stair tread (or other building component) may vary. Considering the embodiment of a stair tread, the overall width W may vary between, for example, approximately 36 inches and approximately 48 inches. Additionally, the dimensions of the substrate 202 and the coating 204 materials may also vary in order to achieve a desired size of the resulting stair tread 200. For example, in some embodiments, the thickness of the coating 204 may be between approximately 0.25 inch and approximately 0.5 inch. Additionally, the size of the substrate may vary based on acceptable tolerances of dimensional lumber or based on commonly accepted sizes in a given geographical market.

As noted above, the coating 204 may exhibit a desired color by providing a colorant in the mixture. Additionally, different “surface finishes” may be molded into the exterior surface of the coating 204 (or into at least one defined surface, such as the “top” surface). For example, the exterior surface of the coating 204 may exhibit a wood grain pattern, a “diamond plate” pattern, a pattern of parallel ridges and grooves, or some other pattern to provide desired grip and/or aesthetics.

As shown in FIG. 3, raised features 206 or other surface elements may be formed in one or more surfaces of the coating 204. For example, the raised features 206 may include a plurality of parallel spaced longitudinal extending elements such that “grooves” 208 or recessed areas are formed between the raised features 206. In other embodiments, the raised features 206 may be formed in a pattern (e.g., such as a diamond plate pattern) or even randomly distributed. Such raised features 206 may provide enhanced traction to an individual that may step or walk on the surface containing the raised elements 206.

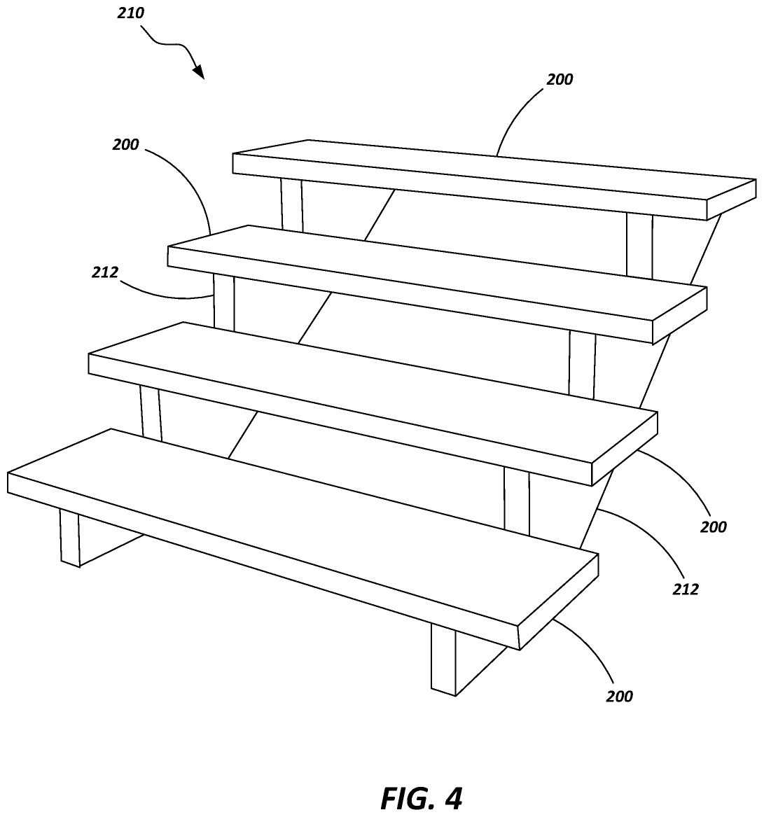

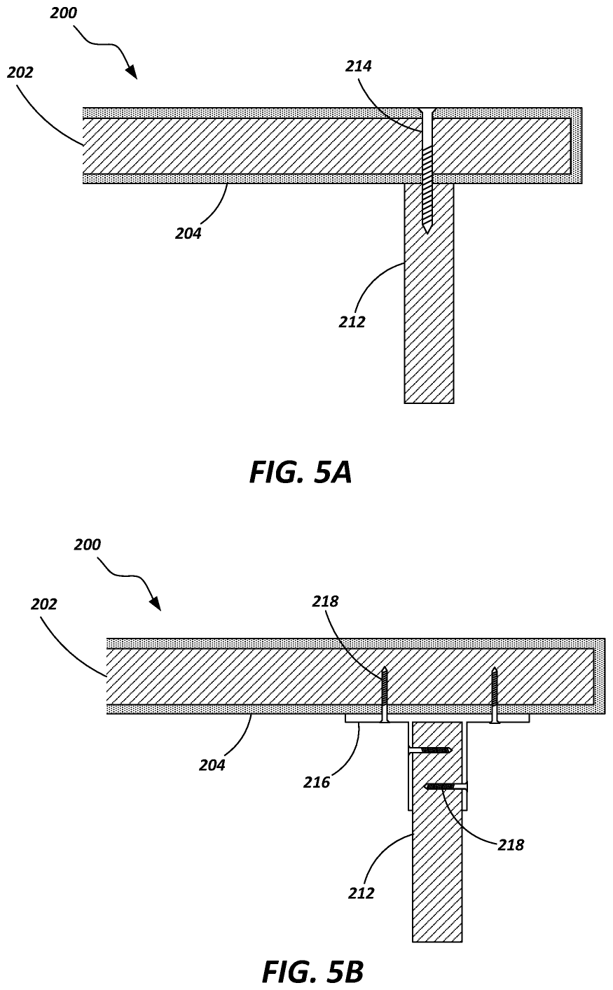

Referring to FIG. 4, a staircase 210 is shown in accordance with an embodiment of the present disclosure. The staircase 210 includes multiple support members, such as stringers 212, and a plurality of stair treads 200 attached to the stringers 212. The stair treads 200 may be attached to the stringers 212 in a variety of ways. For example, referring to FIG. 5A, the stair tread 200 may be coupled with the stringer 212 using a standard wood screw or deck screw 214. The use of a wooden material (or similar type material) as a substrate 202 to form the stair tread 200 enables the use of mechanical fasteners, such as a deck screw, for direct assembly of the stair treads 200 with the stringers 212 and/or other components of a staircase, making the assembly of the staircase 210 both efficient and reliable through the use of known and tested building practices.

Referring to FIG. 5B, in accordance with another embodiment of the present disclosure, the stair tread 200 may be attached to a stringer 212 (or other structure or component) by use of a bracket 216 or other structure. In one embodiment, the bracket 216 may be attached to the stringer by appropriate mechanical fasteners 218 (e.g., deck screws) and may be further attached to the stair tread 200 by way of appropriate mechanical fasteners 218. In other embodiments, the bracket 216 may be formed as an integral part of the stringer 212 (e.g., as a molded, cast, or machined part of a metal stringer). In a further embodiment, while not shown, the bracket 216 may be attached to, or otherwise formed with, the substrate 202 prior to application of the coating 204 to the substrate 202. In some embodiments, the stringer 212 may be formed of metal and a bracket may be welded to a stringer with fasteners attaching the stair tread 200 to the stringer 212. In another embodiment, the stringer may have a flange through which one or more openings or apertures are formed and through which a fastener may pass to attach to a stair tread. Other methods of attachment are also contemplated, and the foregoing examples are not to be considered limiting in any sense.

While embodiments of the disclosure may be susceptible to various modifications and alternative forms, specific embodiments have been shown by way of example in the drawings and have been described in detail herein. However, it should be understood that the embodiments are not intended to be limited to the particular forms disclosed. Rather, the invention includes all modifications, equivalents, and alternatives falling within the spirit and scope of the invention as defined by the following appended claims.

What is claimed is:

1. A stair tread comprising:
a substrate;
a coating over at least a portion of the substrate, the coating comprising rubber and urethane.

2. The stair tread of claim 1, wherein the substrate comprises a length of dimensional lumber.

3. The stair tread of claim 2, wherein the coating further comprises water and a colorant, and wherein the rubber comprises recycled rubber.

4. The stair tread of claim 2, wherein the coating exhibits a thickness of approximately 0.375 inch.

5. The stair tread of claim 2, wherein the coating entirely envelopes the substrate.

6. The stair tread of claim 1, wherein a pattern of raised features is molded into a surface of the coating.

7. A staircase comprising:
at least one stringer;
at least one stair tread coupled with the at least one stringer, the at least one stair tread comprising a substrate and a coating over at least a portion of the substrate, the coating comprising rubber and urethane.

8. The staircase of claim 7, wherein the at least one stair tread is coupled directly to the at least one stringer by way of a wood screw.

9. The staircase of claim 8, wherein the substrate comprises a length of dimensional lumber.

10. The staircase of claim 9, wherein the coating further comprises water and a colorant, and wherein the rubber comprises recycled rubber.

11. The staircase of claim 9, wherein the coating exhibits a thickness of approximately 0.375 inch.

12. The staircase of claim 9, wherein the coating entirely envelopes the substrate.

13. The staircase of claim 7, wherein a pattern of raised features is molded into a surface of the coating.

14. The staircase of claim 7, wherein the at least one stair tread is attached to the at least one stringer by way of a bracket.

15. The staircase of claim 7, wherein the at least one stringer includes a plurality of stringers and wherein the at least one stair tread includes a plurality of stair treads.

16. A method of forming a building component, the method comprising;
providing a mixture of rubber and urethane;
placing a substrate in a mold;
surrounding the substrate with the mixture; and
bonding the mixture to the substrate.

17. The method according to claim 16, wherein providing a mixture includes forming a mixture comprising:
approximately 8% to approximately 12% by weight of urethane;
approximately 2% to approximately 5% by weight of water;
approximately 81% to approximately 90% by weight of rubber.

18. The method according to claim 17, further comprising forming the mixture with at least one of a colorant, a fire retardant, and a UV inhibitor.

19. The method according to claim 17, wherein forming the mixture includes providing rubber at a size of approximately 20 mesh.

20. The method according to claim 19, wherein bonding the mixture to the substrate includes subjecting the substrate and the mixture to a temperature of between approximately 100° C. and approximately 130° C. and a pressure of between approximately 80 bar and approximately 110 bar for a time of approximately 12 minutes.

21. The method according to claim 21, further comprising molding a pattern of raised elements into a surface of the mixture.

22. The method according to claim 16, further comprising providing the substrate as a length of dimensional lumber.

23. The method according to claim 22, wherein bonding the mixture to the substrate results in a coating of approximately 0.375 inch of the mixture on the substrate.
